(19) United States
(12) Patent Application Publication
(10) Pub. No.: US 2012/0052802 A1
(43) Pub. Date: Mar. 1, 2012

(54) ADVERTISEMENT OF AN EXISTING WIRELESS CONNECTION

(75) Inventors: Mika KASSLIN, Espoo (FI); Miika Laaksonen, Espoo (FI)

(73) Assignee: Nokia Corporation, Espoo (FI)

(21) Appl. No.: 12/862,282

(22) Filed: Aug. 24, 2010

(51) Int. Cl. H04B 7/24

(52) U.S. Cl. 455/41.2

(57) ABSTRACT

Method, apparatus, and computer program product enable devices to advertise an existing connection to other devices so that they can synchronize to the connection and listen to the information exchanged, in a listen-only mode. In example embodiments, after a slave device has joined a piconet by completing a connection with a master device using for example the Bluetooth Low Energy protocol, the slave device possesses all of the information needed to advertise the existing connection to other devices so that they can synchronize to the connection and listen to the information exchanged, in a listen-only mode. The slave device may assume the role of an advertiser of the existing connection and may begin transmitting an advertising channel packet/PDU to inform third party devices about the existing connection. When a third party device receives such an advertising channel packet, it may adopt the connection parameters from the packet and synchronize to the existing connection to start receiving packets in the connection, in a receive-only mode.

### FIELD

The field of the invention relates to wireless communication and more particularly to wireless communication devices capable of advertising existing wireless communication connections.

### BACKGROUND

Perhaps the best-known example of wireless personal area network (PAN) technology is Bluetooth Standard, which operates in the 2.4 GHz ISM band. Bluetooth is a short-range radio network, originally intended as a cable replacement. Bluetooth Technical Specifications are published by the Bluetooth SIG, Inc. Bluetooth Specification version 2.0+EDR, published Oct. 15, 2004 has the original functional characteristics of the first version Bluetooth Basic Rate (BR) and adds the Enhanced Data Rate (EDR) feature. Bluetooth Specification version 2.1+EDR, published Jul. 26, 2007 for Basic Rate/Enhanced Data Rate (BR/EDR), added definitions for new features: Encryption Pause Resume, Erroneous Data reporting, Extended Inquiry Response, Link Supervision Timeout Event, Packet Boundary Flag, Secure Simple Pairing, Sniff Subrating. Bluetooth Specification version 3.0+HS, published Apr. 21, 2009, updated the standard to integrate the Alternate MAC/PHY and Unicast Connectionless Data features.

On Apr. 20, 2009, Bluetooth SIG presented the new Bluetooth Low Energy protocol. Bluetooth Low Energy (LE) is a communication protocol directed to optimize power consumption of devices while being connected to other devices. The Bluetooth Low Energy packets include a preamble used for radio synchronization, an access address used for physical link identification, a shorter protocol data unit (PDU) to carry the payload data and the PDU header information, and a cyclic redundancy code (CRC) to ensure correctness of the data in the PDU.

On Jun. 30, 2010, the Bluetooth SIG published the Bluetooth Core Specification, Version 4.0 (incorporated herein by reference), which includes the Bluetooth Low Energy (LE) protocol for products that require lower power consumption, lower complexity, and lower cost than would be possible using the BR/EDR protocol. Bluetooth LE is designed for applications requiring lower data rates and shorter duty cycles, with a very-low power idle mode, a simple device discovery, and short data packets. Bluetooth LE devices employ a star topology, where one device serves as a master for a plurality of slave devices, the master dictating connection timing by establishing the start time of the first connection event and the slave devices transmitting packets only to the master upon receiving a packet from the master. According to Bluetooth LE communication protocol all connections are point-to-point connections between two devices (the master and the slave).

### SUMMARY

According to an example embodiment of the invention, a method comprises the steps of:

forming a wireless communication connection with a device; and

transmitting an advertising message to inform other devices about the existing wireless communication connection.

In an example embodiment, a computer readable medium storing program instructions, which when executed by a computer processor, performs the immediately preceding method steps.

In example embodiments of the invention, the advertisement message includes information enabling a receiving device to synchronize to the connection.

In example embodiments of the invention, the advertisement message is transmitted on an advertisement channel.

In example embodiments of the invention, the advertisement message is transmitted on an advertisement Bluetooth LE channel.

In example embodiments of the invention, the wireless communication connection is a point-to-point connection.

According to another example embodiment, a method comprises the steps of:

receiving an advertising message including information relating to an existing wireless communication connection;

adopting connection information from the received advertising message;

synchronizing to the existing wireless communication connection using the connection information; and

receiving packets exchanged within the wireless communication connection.

In an example embodiment, a computer readable medium storing program instructions, which when executed by a computer processor, performs the immediately preceding method steps.

In example embodiments of the invention, receiving the advertising message in a listen-only mode.

In an example embodiment, an apparatus comprises:

at least one processor; at least one memory including computer program code;

the at least one memory and the computer program code configured to, with the at least one processor, cause the apparatus at least to:

form a wireless communication connection with a device; and

transmit an advertising message to inform other devices about the existing wireless communication connection.

In an example embodiment, an apparatus comprises:

at least one processor; at least one memory including computer program code;

the at least one memory and the computer program code configured to, with the at least one processor, cause the apparatus at least to:

receive an advertising message including information relating to an existing wireless communication connection;

adopt connection information from the received advertising message;

synchronize to the existing wireless communication connection using the connection information; and

receive packets exchanged within the wireless communication connection.

Accordingly, wireless communication devices are capable of advertising existing wireless communication connections.

### DESCRIPTION OF THE FIGURES

FIG. 1A is an example embodiment of a wireless network using the Bluetooth LE protocol, after a slave device has joined a piconet by completing a connection with a master device using the Bluetooth LE protocol

FIG. 1B is an example embodiment of the wireless network of FIG. 1A, wherein the slave device possesses all of the information needed to advertise the existing connection to other devices so that they can synchronize to the connection and listen to the information exchanged, in a listen-only mode without affecting the connection handling in either the master device, or in the slave device. The slave device may assume the role of an advertiser of the existing connection and may begin transmitting an advertising channel packet/PDU to inform third party devices about the existing connection.

FIG. 1C is an example embodiment of the wireless network of FIG. 1B, wherein the third party device scans for and receives the advertising channel packet, and it may adopt the connection parameters from the packet and synchronize to the existing connection to start receiving packets in the connection in a listen-only mode.

FIG. 1D is an example alternate embodiment of the wireless network of FIG. 1A, wherein both the master device and slave device possess all of the information needed to advertise the existing connection to other devices so that they can synchronize to the connection and listen to the information exchanged, in a listen-only mode without affecting the connection handling in either the master device, or in the slave device. The master device may assume the role of an advertiser of the existing connection and may begin transmitting an advertising channel packet/PDU to inform third party devices about the existing connection. The third party device scans for and receives the advertising channel packet from the master device, and it may adopt the connection parameters from the packet and synchronize to the existing connection to start receiving packets in the connection in a receive-only mode, as shown in FIG. 1C.

FIG. 1E is an example use case for the embodiment of the wireless network of FIG. 1C, wherein the master device may be a Bluetooth enabled cellular telephone, the slave device may be a digital watch that utilizes Bluetooth LE technology to display Caller ID information transmitted from the cellular telephone, and the third device using the Bluetooth LE protocol and sharing the connection between the master and slave devices, may be a digital directory of business contacts combined with an appointment calendar, which may receive Caller ID data from the cellular telephone master device and it may receive time of day data from the digital watch slave device.

FIG. 1F is an example use case for the embodiment of the wireless network of FIG. 1C, wherein the master device may be a Bluetooth enabled a heart rate monitor worn by a heart patient, the slave device may be the patient's digital watch that utilizes Bluetooth LE technology to display the heart rate information transmitted from the monitor, and the third device may be a Bluetooth LE enabled cellular telephone sharing the connection between the master and slave devices, which receives heart rate data from the heart rate monitor master device and receives time of day data from the digital watch slave device.

FIG. 2A is an example embodiment of the internal architecture of the wireless master device and the slave device of FIG. 1A, after the connection between them is formed and the slave device prepares its advertising channel packet buffer with data characterizing the connection.

FIG. 2B is an example embodiment of the internal architecture of the slave device and the third party device of FIG. 1A, after the slave/advertiser device has transmitted the contents of its advertising channel packet buffer as the advertising channel packet to the third party device that has been scanning and has received the advertising channel packet.

FIG. 3 is an example packet structure of advertising channel packet, according to at least one embodiment.

FIG. 4 is an example embodiment of a flow diagram of a method, from the point of view of the advertiser device, according to at least one embodiment.

FIG. 5 is an example embodiment of a flow diagram of a method, from the point of view of the third party receiving device, according to at least one embodiment.

FIG. 6 is an example embodiment of a timing diagram for advertising of an existing connection when the connection event start time is indicated with a time offset from the advertising channel packet, according to at least one embodiment.

FIG. 7 is an example embodiment of a timing diagram for advertising of an existing connection when the connection event start time is indicated as an event start time window and window offset with the advertising channel packet as time reference, according to at least one embodiment.

### DISCUSSION OF EXAMPLE EMBODIMENTS OF THE INVENTION

In example embodiments of the invention, devices are able to advertise an existing connection to other devices so that the other devices can synchronize to the connection and listen to the information exchanged in a listen-only mode without affecting the connection. In an example embodiment of the invention, after a slave device has joined a piconet by completing a connection with a master device using for example the Bluetooth Low Energy (LE) communication protocol, the slave device possesses all of the information needed to advertise the existing connection to other devices so that they can synchronize to the connection and listen to the information exchanged, in a listen-only mode. The slave device may assume the role of an advertiser of the existing connection and may begin transmitting an advertising channel packet/PDU to inform third party devices about the existing connection. Both the master the and the slave device of the existing connection know the connection's parameters, including event timing and channel usage and they both may use the advertising channel packet/PDU to inform third party devices about the existing connection. When a third party device receives such an advertising channel packet, it may adopt the connection parameters from the packet and synchronize to the existing connection to start receiving the packets exchanged between the master and slave devices in the connection in a listen-only mode. According to an example embodiment, the master device and the slave device of the existing connection don't recognize existence of third party listen-only mode devices but they operate the connection as any point-to-point Bluetooth LE connection

In an example embodiment of the invention, more than two devices may operate in a point-to-point connection for example in the Bluetooth Low Energy (LE) protocol for applications that need more flexible role combinations. Devices are able to advertise the existing connection to other devices so that they can synchronize to the connection and listen to the information exchanged, in a listen-only mode without affecting the connection handling in either the master device, or in the slave device. This feature has no effect on the handling of the connection in the master and the slave devices. For example, a slave device may transmit to multiple devices that share its connection to a master device. For example, the master device may be a Bluetooth enabled cellular telephone and the slave device may be a digital watch that utilizes Bluetooth LE technology to display Caller ID information transmitted from the cellular telephone. A third device using the Bluetooth LE protocol and sharing the connection between the master and slave devices, may be a digital directory of business contacts combined with an appointment calendar. The third device may receive Caller ID data from the cellular telephone master device to access and display business contact information and it may receive time of day data from the digital watch slave device to access and display appointments in the calendar. As another example, the master device may be a Bluetooth enabled heart rate monitor worn by a heart patient and the slave device may be the patient's digital watch that utilizes Bluetooth LE technology to display the heart rate information transmitted from the monitor. The third device may be a Bluetooth LE enabled cellular telephone sharing the connection between the master and slave devices, which receives heart rate data from the heart rate monitor master device and receives time of day data from the digital watch slave device, the third device programmed to determine if the heart rate has been above or below predefined thresholds for an extended period and, in response, to send a telephone call alarm to obtain emergency assistance.

A Bluetooth LE radio operates in the unlicensed 2.4 GHz ISM band, in the same manner as does the Basic Rate/Enhanced Data Rate (BR/EDR) radio. Bluetooth LE supports very short data packets, from 8 octets to a maximum of 27 octets, giving it a low duty cycle. Bluetooth LE employs a frequency hopping transceiver with many Frequency Hopping Spread Spectrum (FHSS) carriers, with a bit rate of 1 Megabit per second (Mb/s).

Bluetooth LE employs two multiple access schemes: Frequency division multiple access (FDMA) and time division multiple access (TDMA). Forty (40) physical channels, separated by 2 MHz, are used in the FDMA scheme. Three (3) are used as advertising channels and 37 are used as data channels. A TDMA based polling scheme is used in which one device transmits a packet at a predetermined time and a corresponding device responds with a packet after a predetermined interval.

The physical channel is sub-divided into time units known as events. Data is transmitted between Bluetooth LE devices in packets that are positioned in these events. There are two types of events: Advertising and Connection events.

Devices that transmit advertising packets on the advertising Physical Layer (PHY) channels are referred to as advertisers. Devices that receive advertising on the advertising channels without the intention to connect to the advertising device are referred to as scanners. Devices that need to form a connection to another device by listening for connectable advertising packets, are referred to as initiators. Transmissions on the advertising PHY channels occur in advertising events.

In the Bluetooth Core Specification, Version 4.0, the Link Layer is a state machine with five states: Standby State, Advertising State, Scanning State, Initiating State, and Connection State. The Link Layer state machine allows only one state to be active at a time. The Link Layer in the Standby State does not transmit or receive any packets and can be entered from any other state. The Link Layer in the Advertising State will be transmitting advertising channel packets and possibly listening to and responding to responses triggered by these advertising channel packets. A device in the Advertising State is known as an advertiser. The Advertising State can be entered from the Standby State. The Link Layer in the Scanning State will be listening for advertising channel packets from devices that are advertising. A device in the Scanning State is known as a scanner. The Scanning State can be entered from the Standby State. The Link Layer in the Initiating State will be listening for advertising channel packets from a specific device and responding to these packets to initiate a connection with that specific device. A device in the Initiating State is known as an initiator. The Initiating State can be entered from the Standby State. The Connection State can be entered either from the Initiating State or the Advertising State. A device in the Connection State is known as being in a connection. Within the Connection State, two roles are defined: the Master Role and the Slave Role. When entered from the Initiating State, the Connection State is in the Master Role. When entered from the Advertising State, the Connection State is in the Slave Role. The Link Layer in the Master Role will communicate with a device in the Slave Role and defines the timings of transmissions. The Link Layer in the Slave Role will communicate with only a single device in the Master Role.

In the Bluetooth Core Specification, Version 4.0, there are four advertising event types: connectable undirected advertising (ADV_IND), connectable directed advertising (ADV_DIRECT_IND), scannable undirected advertising (ADV_SCAN_IND), and non-connectable undirected advertising (ADV_NONCONN_IND). At the start of each advertising event, the advertiser sends an advertising packet corresponding to the advertising event type. The scanner device, also referred to as the initiator device, that receives the advertising packet, may make a connect request (CONNECT_REQ) to the advertiser device on the same advertising PHY channel. The CONNECT_REQ request includes fields for access address AA, CRC, WinSize, WinOffset, Interval, Latency, Timeout, ChannelMap, Hop count, and sleep clock accuracy SCA. When the advertiser device accepts the CONNECT_REQ request, a point-to-point connection results between the scanner/initiator device that becomes the master device, and the advertiser device that becomes the slave device in a piconet. Only the master and the slave devices know at what time and in which frequency the connection is in operation. The data channel changes between every connection event and the start of connection events are spaced regularly with the connection interval that is provided in the CONNECT_REQ packet. In a non-connectable undirected event type advertising channel packet, ADV_NONCONN_IND, a scanner device is allowed to receive information in the advertising channel packet, but scanner devices are not allowed to transmit anything in the advertising channels upon receiving the ADV_NONCONN_IND advertising channel packets. When the non-connectable undirected event type is used, non-connectable advertising indications ADV_NONCONN_IND packets are sent by the Link Layer. The non-connectable undirected event type allows a scanner to receive information contained in the ADV_NONCONN_IND from the advertiser. The advertiser may either move to the next used advertising channel index or close the advertising event after each ADV_NONCONN_IND that is sent. The Link Layer does not listen, and therefore cannot receive any requests from scanners or initiators.

In the Bluetooth Core Specification, Version 4.0, if the advertiser is using a connectable advertising event, a scanner/initiator may make a connection request using the same advertising PHY channel on which it received the connectable advertising packet. The advertising event is ended and connection events begin if the advertiser receives and accepts the request for a connection to be initiated. Once a connection is established, the scanner/initiator becomes the master device in a piconet and the advertising device becomes the slave device. Within a connection event, the master and slave alternate sending data packets using the same data PHY channel. In the Bluetooth Core Specification, Version 4.0, the Bluetooth LE devices employ a star topology, where one device serves as a master for a plurality of slave devices, the master dictating connection timing by establishing the start time of the first connection event and the slave devices transmitting packets only to the master upon receiving a packet from the master.

In an example embodiment of the invention, low power wireless communication devices may form point-to-point communication links, more particularly in the Bluetooth Low Energy (LE) protocol. Devices are able to advertise the existing connection to other devices so that they can synchronize to the connection and listen to the information exchanged, in a listen-only mode without affecting the connection handling in either the master device, or in the slave device. In example embodiments of the invention, after a slave device has joined a piconet by completing a connection with a master device using the Bluetooth LE protocol, the slave device possesses all of the information needed to advertise the existing connection to other devices so that they can synchronize to the connection and listen to the information exchanged, in a listen-only mode without affecting the connection handling in either the master device, or in the slave device. The slave device may assume the role of an advertiser of the existing connection and may begin transmitting an advertising channel packet/PDU (ADV_EXTENSION_IND) to inform third party devices about the existing connection. Both the master the and the slave device of the existing connection know the connection's parameters, including event timing and channel usage and either device may use the advertising channel packet/PDU, ADV_EXTENSION_IND, to inform third party devices about the existing connection. Rules applied to the ADV_EXTENSION_IND advertising event type are preferably similar to the rules of the non-connectable undirected event type ADV_NONCONN_IND that allows a scanning device to receive information in the advertising channel packets. Scanning devices are not allowed to transmit anything in the advertising channels upon receiving the advertising channel packets. When a third party device receives the advertising channel packet ADV_EXTENSION_IND, it does not transmit a response in the advertising channel. The third party device may adopt the connection parameters from the ADV_EXTENSION_IND packet and synchronize to the existing connection to start receiving the data packets exchanged between the master and slave devices in the connection, in a listen-only mode.

Example non-limited use cases for Bluetooth LE technology include sports and fitness, security and proximity and smart energy. Bluetooth LE technology is designed for devices to have a battery life of up to one year such as those powered by coin-cell batteries. These types of devices include watches that will utilize Bluetooth LE technology to display Caller ID information and sports sensors that will be utilized to monitor the wearer's heart rate during exercise. The Medical Devices Working Group of the Bluetooth SIG is also creating a medical devices profile and associated protocols to enable Bluetooth applications for Bluetooth LE devices.

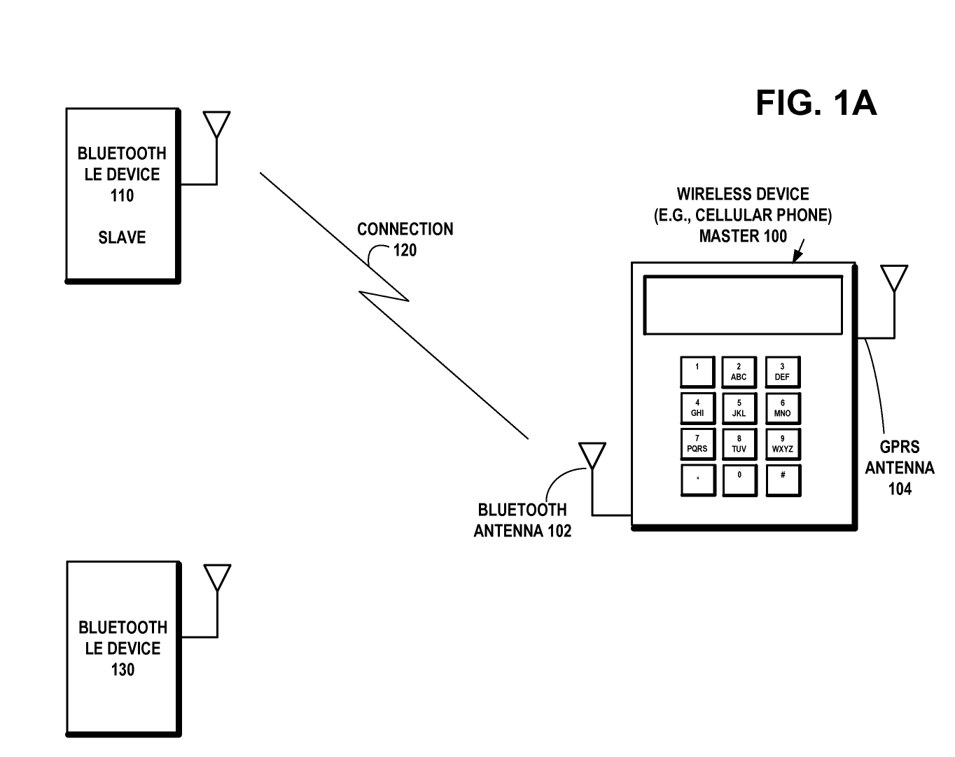

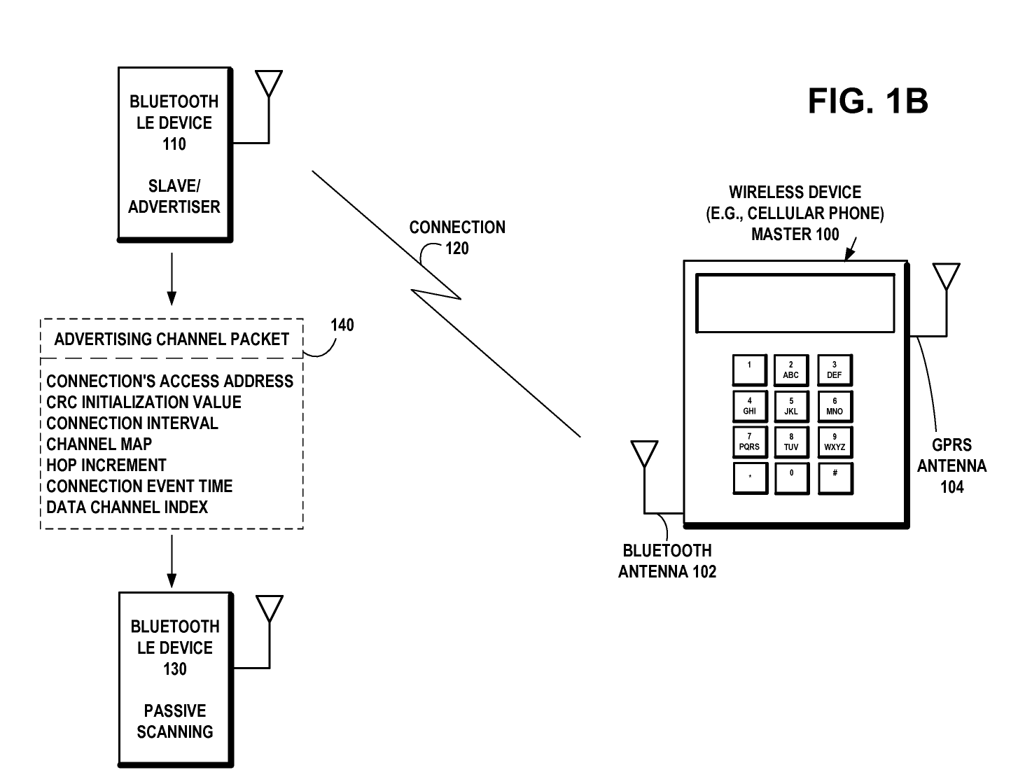

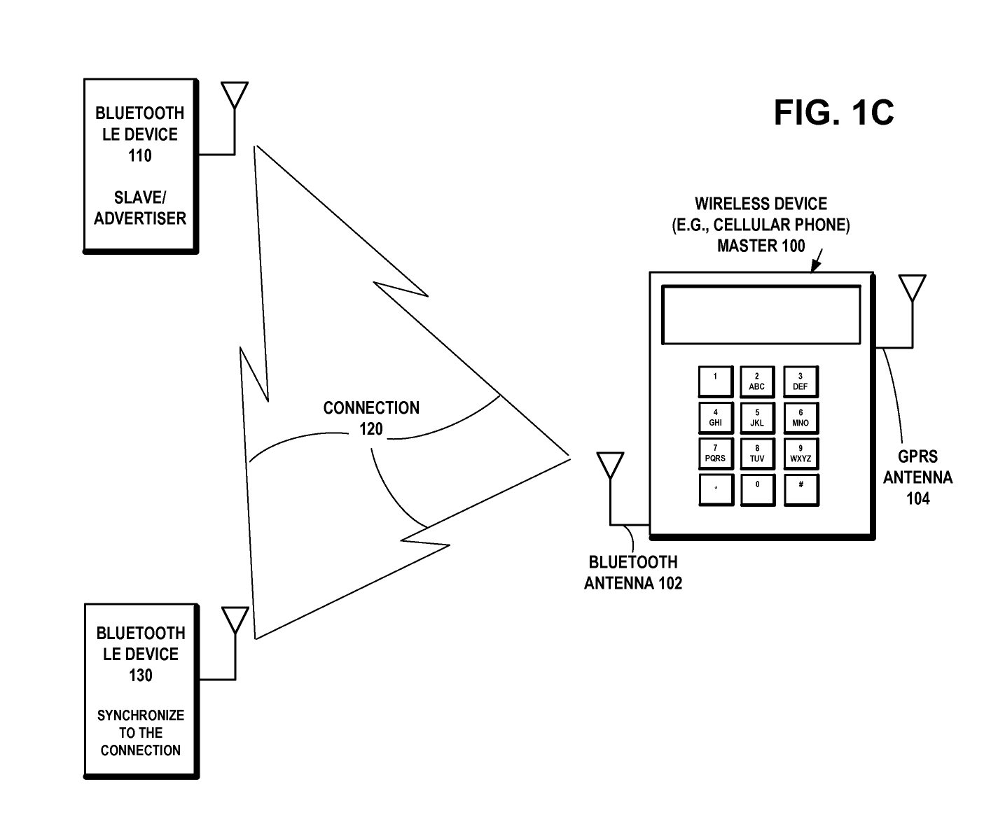

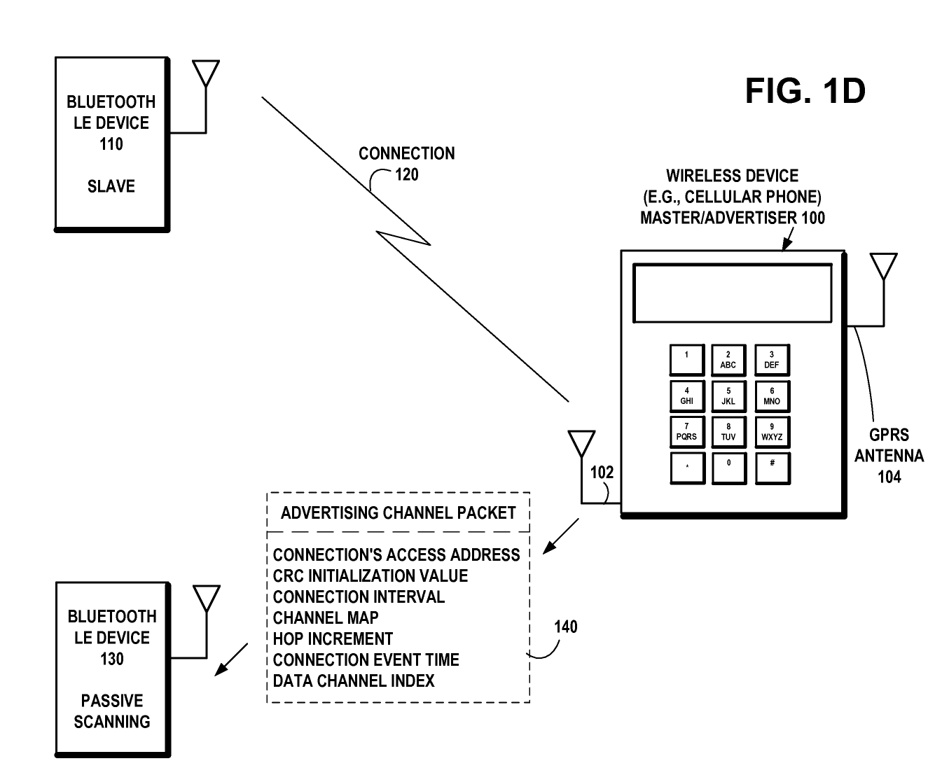

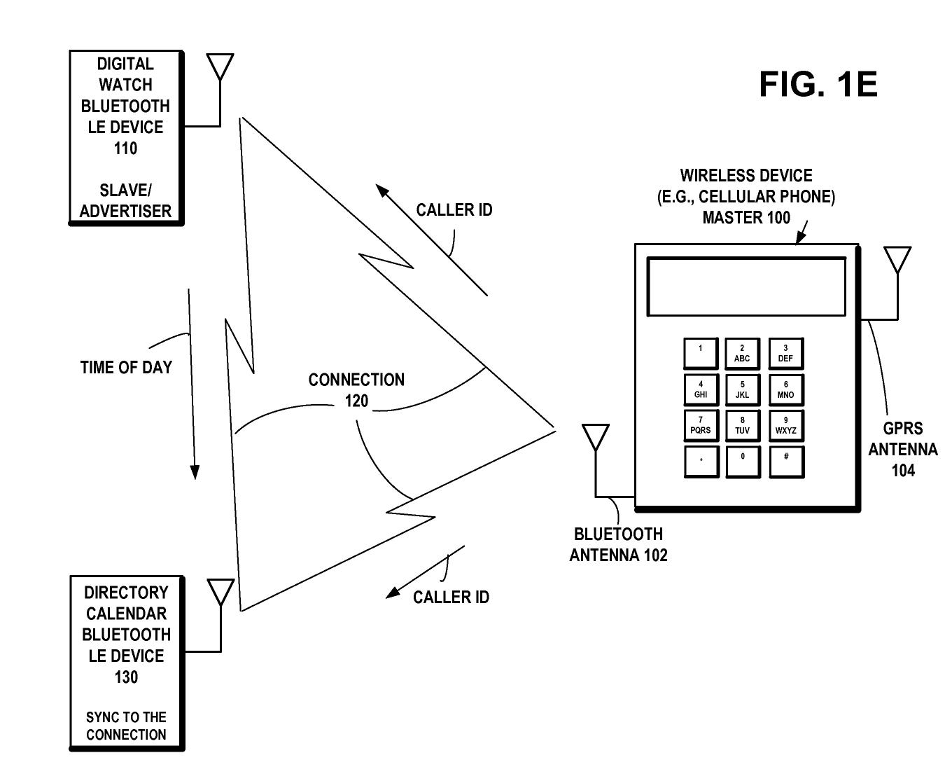

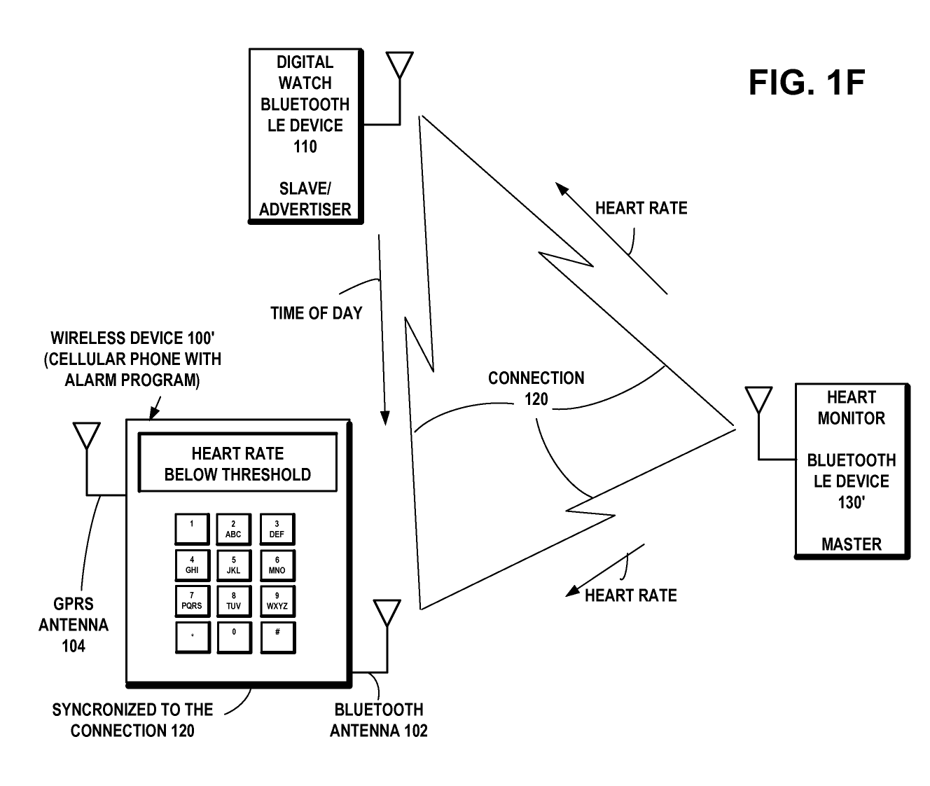

FIG. 1A is an example embodiment of a wireless network using the Bluetooth LE protocol, after a slave device 110 has joined a piconet by completing a connection 120 with a master device 100 using the Bluetooth LE protocol. For example, master device 100 may be a cellular telephone with a Bluetooth antenna 102 and a cellular GPRS antenna 104. Slave device 110 may be a digital watch that utilizes Bluetooth LE technology to display Caller ID information transmitted from the cellular telephone 100. A third party device 130 using the Bluetooth LE protocol, may be a digital directory of business contacts combined with an appointment calendar that may receive Caller ID data from device 100 to access and display business contact information and receive time of day data from device 110 to access and display appointments in the calendar. The connection 120 in FIG. 1A is a point-to-point connection between the master device 100 and the slave device 110. The third party device 130 is shown as not connected to the other devices 100 or 110 in FIG. 1A.

FIG. 1B is an example embodiment of the wireless network of FIG. 1A, wherein the slave device 110 possesses all of the information needed by the third party device 130 to synchronize to the existing connection 120 and start receiving packets in the connection 120 exchanged between the master device 100 and the slave device 110, in a listen-only mode without affecting the connection handling in either the master device 100, or in the slave device 110. This information includes the connection's access address, the CRC initialization value, the connection interval, the channel map, the hop increment, the connection event time, and the data channel index. The slave device 110 may assume the role of an advertiser of the existing connection 120. The slave device 110 may begin transmitting an advertising channel packet/PDU, ADV_EXTENSION_IND 140 containing this information to inform third party devices, such as device 130, about the existing connection 120.

FIG. 1C is an example embodiment of the wireless network of FIG. 1B, wherein the third party device 130 scans for, receives, and recognizes the advertising channel packet 140. The third party device 130 may adopt the connection parameters from the packet 140 and synchronize to the existing connection 120 to start receiving packets exchanged between the master device 100 and the slave device 110 in the connection 120 in a listen-only mode. In this manner, devices 100 and 110 continue communicating over an unaltered point-to-point communication link whereas device 130 is capable of listening to the radio traffic communicated by devices 100 and 110 over the point-to-point communication link. The master device 100 and the slave device 110 run the connection 120 as any Bluetooth LE connection and third party device 130 in a listen-only mode has no effect on the handling of the connection.

The third party scanning device 130 may discover existing connections by scanning passively. The third party scanning device 130 may use e.g. a device address as a scanning parameter to discover connections of a specific device, such as the slave device 110. The third party scanning device 130 that wishes to join an existing link layer connection 120 as a listen-only device, must first receive an advertising channel packet ADV_EXTENSION_IND 140 for the connection 120 that the third party scanning device 130 seeks to discover. Once the third party scanning device 130 has received such an advertising channel packet ADV_EXTENSION_IND 140, it may synchronize to the connection 120 and start receiving packets transmitted between the master 100 and the slave 110 devices in the connection 120. Upon receiving an advertising channel packet ADV_EXTENSION_IND 140 for the proper connection 120, the third party scanning device 130 determines the data channel for the next or a subsequent connection event. The third party scanning device 130 then tunes to the channel 120 and starts listening for the packets in the connection 120. If the event start time is given as an absolute value in the advertising channel packet ADV_EXTENSION_IND 140, the event is assumed to start at the specified time. But, if a time window is given in advertising channel packet ADV_EXTENSION_IND 140, the event is assumed to start within the window. In general, the operations are similar to those performed by the slave 110 in the connection 120, except that the third party device 130 that joins the connection 120 as a listen-only device does not transmit anything in the connection 120.

FIG. 1D is an example alternate embodiment of the wireless network of FIG. 1A, wherein the both the master device 100 and slave device 110 possesses all of the information needed by the third party device 130 to synchronize to the existing connection 120 and start receiving packets exchanged between the master device 100 and the slave device 110 in the connection, in a listen-only mode. The master device 100 may assume the role of an advertiser of the existing connection 120 and may begin transmitting an advertising channel packet/PDU ADV_EXTENSION_IND 140 to inform third party devices, such as device 130, about the existing connection 120. The third party device 130 scans for and receives the advertising channel packet 140 from the master device 100, and it may adopt the connection parameters from the packet 140 and synchronize to the existing connection 120 to start receiving packets exchanged between the master device 100 and the slave device 110 in the connection in a listen-only mode without affecting the connection handling in either the master device 100, or in the slave device 110, as shown in FIG. 1C.

FIG. 1E is an example use case for the embodiment of the wireless network of FIG. 1C, wherein the master device may be a Bluetooth enabled cellular telephone 100, the slave device may be a digital watch 110 that utilizes Bluetooth LE technology to display Caller ID information transmitted from the cellular telephone 100, and the third device using the Bluetooth LE protocol and sharing the connection between the master and slave devices, may be a digital directory of business contacts combined with an appointment calendar 130. The third device 130 may receive Caller ID data from the cellular telephone 100 master device to access and display business contact information and it may receive time of day data from the digital watch 110 slave device to access and display appointments in the calendar.

FIG. 1F is an example use case for the embodiment of the wireless network of FIG. 1C, wherein the master device may be a Bluetooth enabled a heart rate monitor 130′ worn by a heart patient, the slave device may be the patient's digital watch 110 that utilizes Bluetooth LE technology to display the heart rate information transmitted from the monitor 130′, and the third device may be a Bluetooth LE enabled cellular telephone 100′ sharing the connection between the master and slave devices, which receives heart rate data from the heart rate monitor 130′ master device and receives time of day data from the digital watch 110 slave device, the third device, cellular telephone 100′, programmed to determine if the heart rate has been above or below predefined thresholds for an extended period and, in response, to send a telephone call alarm to obtain emergency assistance.

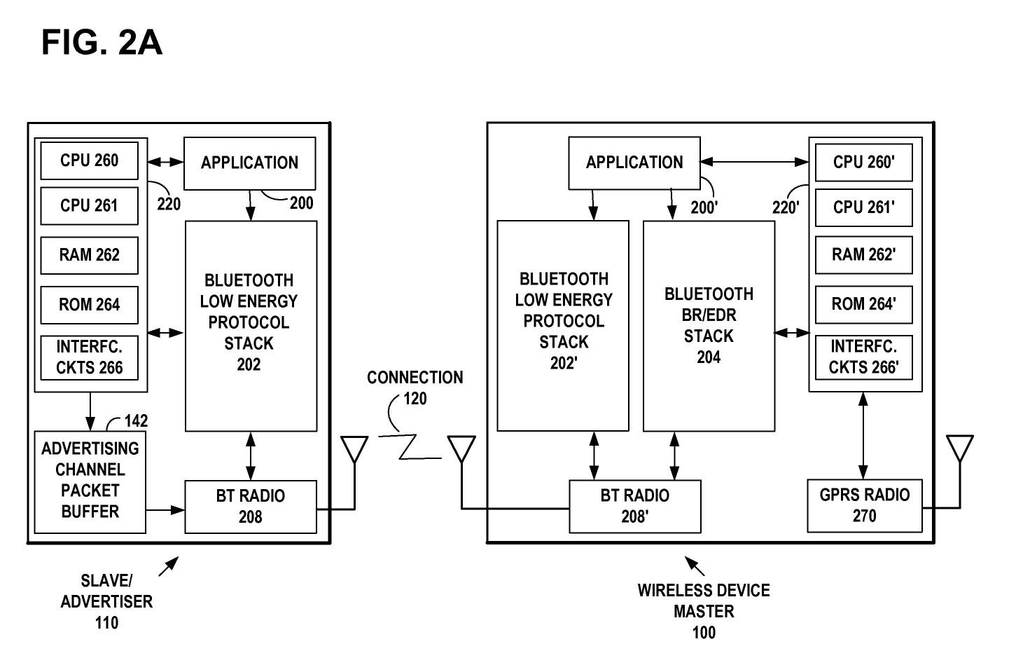

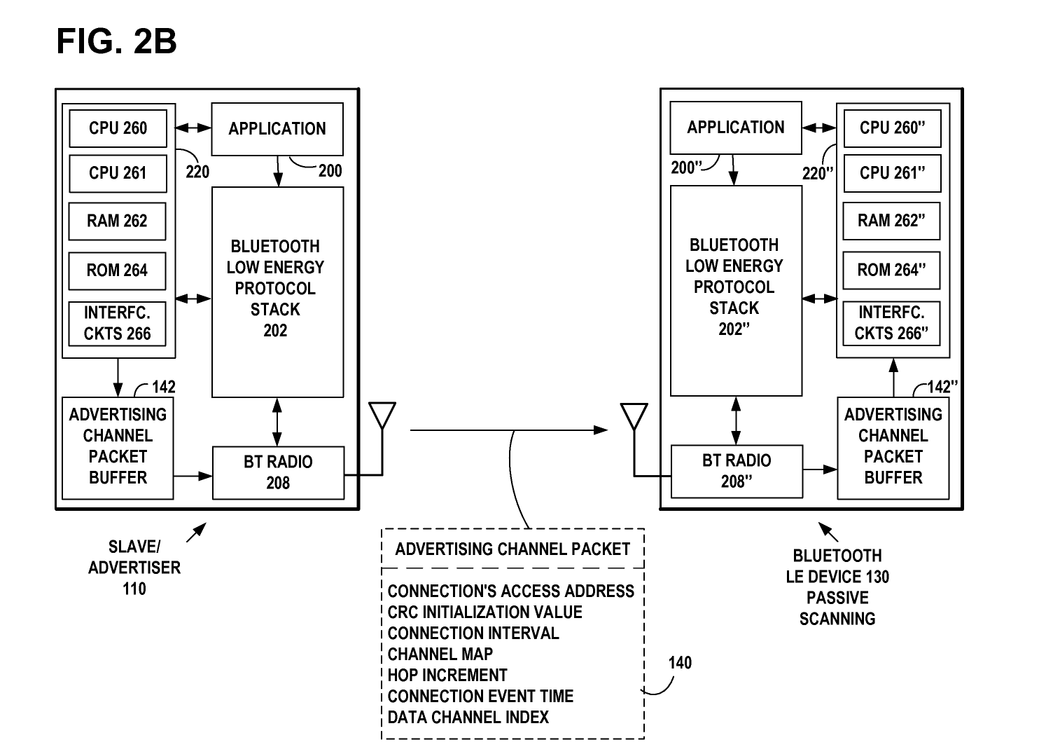

FIG. 2A is an example embodiment of the internal architecture of the wireless master device 100 and the slave device 110 of FIG. 1A, after the connection 120 between them is formed and the slave device 110 prepares its advertising channel packet buffer 110 with data characterizing the connection 120. FIG. 2B is an example embodiment of the internal architecture of the slave device 120 and the third party device 130 of FIG. 1A, after the slave/advertiser device 110 has transmitted the contents of its advertising channel packet buffer 142 as the advertising channel packet ADV_EXTENSION_IND 140 to the third party device 130 that has been scanning and has received the advertising channel packet 140.

The wireless master device 100 may be a Bluetooth enabled communications device, PDA, cell phone, laptop or palmtop computer, or the like or it may be a stationary access point, automotive dashboard interface, home electronics interface or other Bluetooth enabled stationary interface or device. The slave device 110 and the third device 130 may be a Bluetooth enabled remote controller, healthcare monitor, sports sensor, token, key fob, watch, wireless keyboard, gaming pad, body sensor, toy, health care equipment, human interface device, entertainment device, wireless microphone, GPS sensor, or the like. The slave device 110, master device 100, and third party device 130 may include a processor 220, 220′, and 220″, respectively, which each includes a dual core central processing unit (CPU) 260 and 261, a random access memory (RAM) 262, a read only memory (ROM) 264, and interface circuits 266 to interface with the radio transceiver 208. The slave device 110, master device 100, and third party device 130 may each further include a battery and other power sources, key pad, touch screen, display, microphone, speakers, ear pieces, camera or other imaging devices, etc. The RAM 262 and ROM 264 may be removable memory devices such as smart cards, SIMs, WIMs, semiconductor memories such as RAM, ROM, PROMS, flash memory devices, etc. according to an embodiment of the present invention. According to an embodiment, the slave device 110, master device 100, and third party device 130 each include the Bluetooth Low Energy protocol stack 202, which is described in the Bluetooth Core Specification, Version 4.0 protocol specification. The master device 100 may also include the Bluetooth BR/EDR protocol stack 204, which is described in the Bluetooth Specification version 3.0+HS.

The processors 220, 220′, and 220″, protocol Bluetooth protocol stacks 202 and 204 and/or application program 200 may be embodied as program logic stored in the RAM 262 and/or ROM 264 in the form of sequences of programmed instructions which, when executed in the CPUs 260 and/or 261, carry out the functions of the disclosed embodiments. The program logic may be delivered to the writeable RAM, PROMS, flash memory devices, etc. 262 of the slave device 110, third device 130, or wireless device 100 from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The Bluetooth radio 208 in the each of the slave device 110, third device 130, and the wireless device 100 may be separate transceiver circuits or alternately, the radio 208 may be a single radio module capable of handling one or multiple channels in a high speed, time and frequency multiplexed manner in response to the processors 220, 220′, and 220″. The program code for instructing the apparatus to perform its various operations may be stored in computer readable media, for example magnetic disks, CD ROMS, or flash memory devices. The program code may be downloaded from such computer readable media to be stored for example in the RAM 262 or programmable ROM 264 of the slave device 110, third device 130, or wireless device 100 for execution of the program code for example by the CPUs 260 and/or 261.

The GPRS radio 270 in the master device 100 may be any of a variety of wireless personal area, wireless local area, or wireless wide area radio devices, such as Land Mobile Radio, Professional Mobile Radio, DECT (Digital Enhanced Cordless Telecommunications), 1G, 2G, 3G, 4G Cellular systems, IrDA, RFID (Radio Frequency Identification), Wireless USB, DSRC (Dedicated Short Range Communications), Near Field Communication, wireless sensor networks, ZigBee, EnOcean; Bluetooth, TransferJet, Ultra-wideband (UWB from WiMedia Alliance), WLAN, IEEE 802.11, WiFi, HiperLAN, Wireless Metropolitan Area Networks (WMAN) and Broadband Fixed Access (BWA) (LMDS, WiMAX, AIDAAS and HiperMAN), or the like.

After the slave/advertiser device 110 has transmitted the contents of its advertising channel packet buffer 142 as the advertising channel packet ADV_EXTENSION_IND 140 to the third party device 130 that has been scanning and has received the advertising channel packet 140, it is buffered in the advertising channel packet buffer 142′ of the third party device 130. The third party device 130 may adopt the connection parameters from the packet 140 and synchronize to the existing connection 120 to start receiving packets exchanged between the master device 100 and the slave device 110 in the connection 120 in a listen-only mode without affecting handling of the connection 120 in either the master device 100, or in the slave device 110.

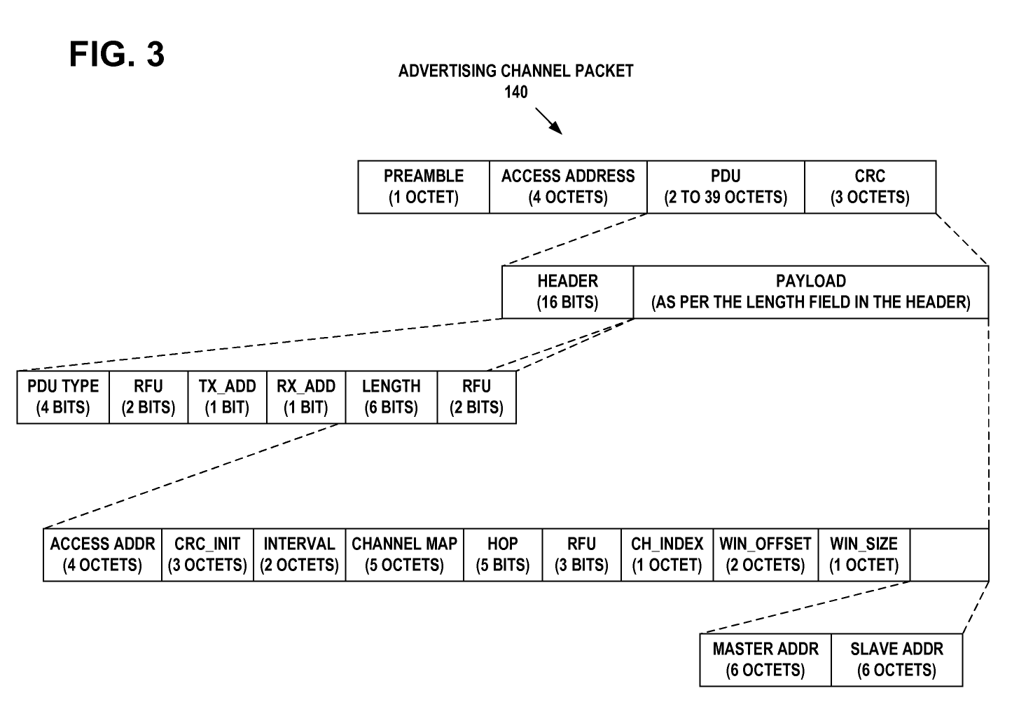

FIG. 3 is an example packet structure of advertising channel packet ADV_EXTENSION_IND 140, according to at least one embodiment. The Bluetooth LE link layer has only one packet format used for both advertising channel packets and data channel packets. Each packet consists of four fields: the preamble, the Access Address, the protocol data unit (PDU), and the cyclic redundancy code (CRC). The preamble is 1 octet and the Access Address is 4 octets. The PDU range is from 2 to a maximum of 39 octets. The CRC is 3 octets. The Access Address for all advertising channel packets is hex value 0x8E89BED6.

The preamble and Access Address are followed by a PDU. The advertising channel PDU has a 16-bit header and a variable size payload. The PDU Type field of the advertising channel PDU that is contained in the header, indicates the PDU type. The TxAdd and RxAdd fields of the advertising channel PDU that are contained in the header, contain information specific to the PDU type defined for each advertising channel PDU. The Length field of the advertising channel PDU header indicates the payload field length in octets, and may be 6 to 37 octets.

The Payload fields in the advertising channel PDUs are specific to the PDU Type. For the advertising channel packet ADV_EXTENSION_IND 140, the example payload field may include the following fields:

AccessAddress=Contains the connection's access address.

CRCInit=Contains the initialization value for the CRC calculation.

Interval=Contains connInterval parameter value.

ChannelMap=Contains the channel map indicating Used and Unused data channels. Every channel is represented with a bit positioned as per the data channel index.

Hop=Indicates the hopIncrement used in the data channel selection algorithm, and has a random value in the range of 5 to 16.

RFU=Reserved for future use

ChIndex=Indicates unmapped data channel index for the connection event advertised.

WinOffset=Indicates start time of the connection event start transmission window.

WinSize=Indicates connection event start transmission window size.

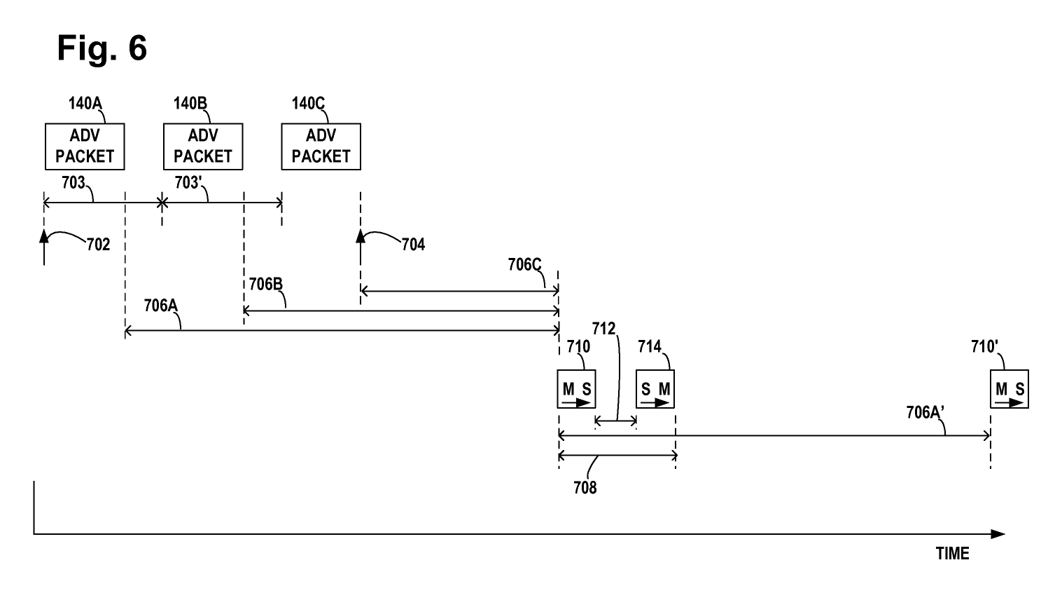

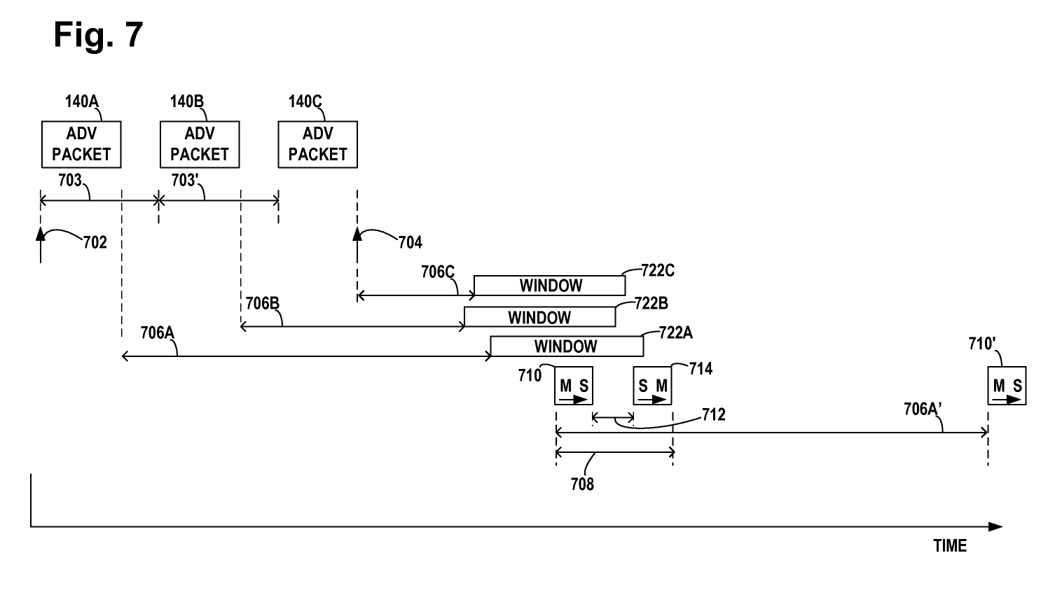

The parameter WinOffset (Connection event time) indicates start time of the next or a subsequent connection event. Alternatively it may indicate start time of one of the following connection events. It necessarily doesn't have to be the next event but any of the connection events whose time and frequency parameters are known. It may be indicated as an absolute value that indicates time from the advertising channel packet/PDU to the beginning of the next or a subsequent connection event, as shown in FIG. 6. Alternatively a time span WinSize may be given to indicate a time window during which the next or a subsequent connection event will start, as shown in FIG. 7.

The parameter ChIndex (Data channel index) indicates the unmapped channel index of the connection event whose start time is indicated with the WinOffset parameter.

Additionally there may be other parameters in the advertising channel packet ADV_EXTENSION_IND 140 that are considered useful e.g. for connection identification purposes. The PDU may, as an example, contain addresses of either or both the master and slave devices of the connection:

MasterAddress=Contains address of the master device in the connection.

SlaveAddress=Contains address of the slave device in the connection.

The advertising channel packet ADV_EXTENSION_IND 140 may also include advertising data describing the advertiser's host, for example, advertising data indicating that the host for the slave/advertiser device 110 is a digital watch.

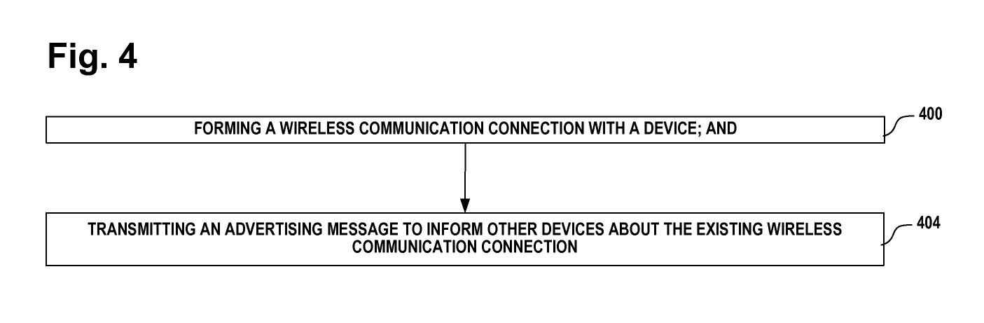

FIG. 4 is an example embodiment of a flow diagram of a method, from the point of view of the slave/advertiser device 110, using the Bluetooth Low Energy protocol, according to at least one embodiment. The steps of the flow diagram represent computer code instructions stored in the RAM and/or ROM memory of the slave/advertiser device 110, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 400: forming a wireless communication connection with a device; and

Step 404: transmitting an advertising message to inform other devices about the existing wireless communication connection.

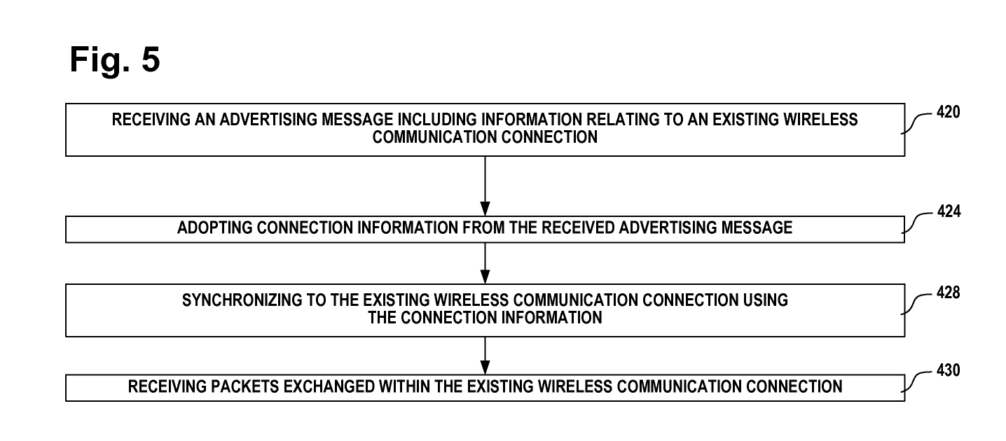

FIG. 5 is an example embodiment of a flow diagram of a method, from the point of view of the receiving device, using the Bluetooth Low Energy protocol according to at least one embodiment. The steps of the flow diagram represent computer code instructions stored in the RAM and/or ROM memory of the receiving third party device 130, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 420: receiving an advertising message including information relating to an existing wireless communication connection;

Step 424: adopting connection information from the received advertising message;

Step 428: synchronizing to the existing wireless communication connection using the connection information; and

Step 430: receiving packets exchanged within the existing wireless communication connection.

The receiving third party device 130 may discover existing connections by scanning passively. The receiving third party device 130 scans for advertising channel packets ADV_EXTENSION_IND 140. The receiving third party device 130 may use e.g. a device address as a scanning parameter to discover connections of a specific device, such as the slave device 110. The third party device 130 may scan for the advertiser's address, either the advertiser's public or random device address in the advertising channel packet ADV_EXTENSION_IND 140. The third party device 130 may scan for specific advertising data describing the advertiser's host in the advertising channel packet ADV_EXTENSION_IND 140, for example, advertising data indicating that the host for the slave/advertiser device 110 is a digital watch.

The receiving third party device 130 that wishes to join an existing link layer connection 120 as a listen-only device, needs to first receive an advertising channel packet ADV_EXTENSION_IND 140 for the connection 120 that the receiving third party device seeks to discover. Once the receiving third party device 130 has received such an advertising channel packet ADV_EXTENSION_IND 140, it may synchronize to the connection 120 and start receiving packets transmitted between the master 100 and the slave 110 devices in the connection. Upon receiving an advertising channel packet ADV_EXTENSION_IND 140 for the proper connection 120, the receiving third party device 130 determines the data channel for one of the next connection events from the Data channel index parameter ChIndex, the Channel map parameter ChannelMap, and the Hop increment parameter Hop. The receiving third party device 130 then tunes to the channel 120 and starts listening for the packets in the connection. If the event start time is given as an absolute value in the advertising channel packet ADV_EXTENSION_IND 140, the event is assumed to start at the specified time. But, if a time window is given in advertising channel packet ADV_EXTENSION_IND 140, the event is assumed to start within the window. In general, the operations for the receiving third party device 130 are similar to those performed by the slave device 110 in the connection 120, except that the third party device 130 that joins the connection 120 as a listen-only device does not transmit anything in the connection.

FIG. 6 is an example embodiment of a timing diagram for the slave/advertiser 110 advertising of an existing connection 120 when the connection event time 706A is indicated with a time offset parameter WinOffset from the occurrence of the end of the advertising channel packet ADV_EXTENSION_IND 140. Three consecutive advertising channel packets ADV_EXTENSION_IND 140A, 140B, and 140C are transmitted, starting at the beginning 702 of the advertising event and transmitted by the device 110 at maximum 10 ms intervals 703 and 703′ until the end 704 of the advertising event. Each advertising channel packet ADV_EXTENSION_IND 140 includes a value for the parameter WinOffset, the connection event time, which indicates the start time of the next connection event 710 when the master device 100 transmits a packet to the slave device 110, as indicated at 710. The consecutive advertising channel packets ADV_EXTENSION_IND 140A, 140B, and 140C respectively include a time offset parameter WinOffset with a duration 706A, 706B, and 706C. The consecutive advertising channel packets ADV_EXTENSION_IND 140A, 140B, and 140C respectively include the data channel index parameter ChIndex that indicates the unmapped channel index 708 of the next connection event 710. FIG. 6 also shows the interval T_IFS between the connection event 710 when the master device 100 transmits a packet to the slave device 110 and the reply transmission 714 from the slave 110 to the master device 100. The second next connection event time 706A′ for the start of the second next connection event 710′ is shown in the FIG. 6, which corresponds to the connection interval parameter Interval in the advertising channel packet ADV_EXTENSION_IND.

FIG. 7 is an example embodiment of a timing diagram for advertising of an existing connection 120 when the connection event start time is indicated in the advertising channel packet ADV_EXTENSION_IND as an event start time window WinSize 722A, 722B, and 722C and window offset WinOffset 720A, 720B, and 720C in the respective advertising channel packets ADV_EXTENSION_IND 140A, 140B, and 140C.

In an example embodiment of the invention, an apparatus comprises:

means for forming a wireless communication connection with a device; and

means for transmitting an advertising message to inform other devices about the existing wireless communication connection.

In an example embodiment of the invention, an apparatus comprises:

means for receiving an advertising message including information relating to an existing wireless communication connection;

means for adopting connection information from the received advertising message;

means for synchronizing to the existing wireless communication connection using the connection information; and

means for receiving packets exchanged within the existing wireless communication connection.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
forming a wireless communication connection with a device; and
transmitting an advertising message to inform other devices about the existing wireless communication connection.

2. The method of claim 1, wherein the wireless communication connection is a point-to-point connection.

3. The method of claim 1, wherein the advertisement message includes information enabling a receiving device to synchronize to the existing wireless communication connection.

4. The method of claim 3, wherein the existing wireless communication connection remains unaltered when the receiving device synchronizes to said connection.

5. The method of claim 1, wherein the advertisement message is transmitted on a Bluetooth Low Energy advertisement channel.

6. A method, comprising:
receiving an advertising message including information relating to an existing wireless communication connection;
adopting connection information from the received advertising message;
synchronizing to the existing wireless communication connection using the connection information; and
receiving packets exchanged within the existing wireless communication connection.

7. The method of claim 6, wherein the existing wireless communication connection is a point-to-point connection.

8. The method of claim 6, wherein the existing connection remains unaltered when synchronizing to said connection.

9. The method of claim 8, wherein radio traffic within the existing connection is only listened to without affecting connection handling of devices transmitting the packets.

10. The method of claim 6, wherein the advertisement message is received on a Bluetooth Low Energy advertisement channel.

11. An apparatus, comprising:
at least one processor;
at least one memory including computer program code;
the at least one memory and the computer program code configured to, with the at least one processor, cause the apparatus at least to:
form a wireless communication connection with a device; and
transmit an advertising message to inform other devices about the existing wireless communication connection.

12. The apparatus of claim 11, wherein the wireless communication connection is a point-to-point connection.

13. The apparatus of claim 11, wherein the advertisement message includes information enabling a receiving device to synchronize to the existing wireless communication connection.

14. The apparatus of claim 13, wherein the existing wireless communication connection remains unaltered when the receiving device synchronizes to said connection.

15. The apparatus of claim 11, wherein the advertisement message is transmitted on a Bluetooth Low Energy advertisement channel.

16. An apparatus, comprising:
at least one processor;
at least one memory including computer program code;
the at least one memory and the computer program code configured to, with the at least one processor, cause the apparatus at least to:
receive an advertising message including information relating to an existing wireless communication connection;
adopt connection information from the received advertising message;
synchronize to the existing wireless communication connection using the connection information; and
receive packets exchanged within the wireless communication connection.

17. The apparatus of claim 16, wherein the existing wireless communication connection is a point-to-point connection.

18. The apparatus of claim 16, wherein the existing connection remains unaltered when the apparatus synchronizes to said connection.

19. The apparatus of claim 18, wherein radio traffic within the existing connection is only listened without affecting connection handling of devices transmitting the packets.

20. The apparatus of claim 16, wherein the advertisement message is received on a Bluetooth Low Energy advertisement channel.

21. A computer program product comprising computer executable program code recorded on a computer readable storage medium, the computer executable program code comprising:
code for forming a wireless communication connection with a device; and
code for transmitting an advertising message to inform other devices about the existing wireless communication connection.

22. A computer program product comprising computer executable program code recorded on a computer readable storage medium, the computer executable program code comprising:
code for receiving an advertising message including information relating to an existing wireless communication connection;
code for adopting connection information from the received advertising message;
code for synchronizing to the existing wireless communication connection using the connection information; and
code for receiving packets exchanged within the wireless communication connection.
